(19) United States
(12) Patent Application Publication
(10) Pub. No.: US 2022/0292608 A1
(43) Pub. Date: Sep. 15, 2022

(54) SYSTEM AND METHOD FOR FINANCIAL SCORING AND FINANCIAL PLANNING

(71) Applicant: Brian Eugene Souder, Ontario, OH (US)

(72) Inventor: Brian Eugene Souder, Ontario, OH (US)

(21) Appl. No.: 17/695,685

(22) Filed: Mar. 15, 2022

Related U.S. Application Data
(60) Provisional application No. 63/161,377, filed on Mar. 15, 2021.

(51) Int. Cl. G06Q 40/08; G06Q 40/00

(52) U.S. Cl. CPC G06Q 40/08; G06Q 40/125

(57) ABSTRACT

The present invention is a device, system, and method for financial scoring and financial planning which provides a solution to the problem of poorly managed personal finances and provides opportunities for individuals, in general, to improve their current finances and planning for future finances. The core components of the invention are a device or system configured to receive input from users and provide scores based on individual user information and personal goals and recommendations for the user. Generally speaking, the device or system receives input from a user related to current finances and goals, the device determines a score based on the user input and provides the score along with recommendations to the user. An individual's finances are broken down and scored in two main categories (Offense and Defense) and evidence is provided on how they are doing as well as how they can improve based on the inputs provided.

This application claims priority to U.S. Provisional Patent No. 63/161,377 filed on Mar. 15, 2021 and is incorporated in its entirety.

### BACKGROUND

Software applications used for evaluating and managing individual finances often provide cookie cutter advice that is not well tailored to the individual's actual life goals and career expectations. These applications often focus on minimizing expenses and optimizing investing strategies. However, this focus on minimizing expenses and optimizing investing strategies often leaves out important short-term and medium-term goals (e.g., saving for a down payment on a house, opening a business, saving for college, etc.) that the individual may have.

Existing financial planning applications are often focused solely on retirement or net worth. Although these are very important considerations, it is often difficult to motivate individuals to take actions today that they will not see benefits from for decades. Furthermore, existing financial planning applications are “goal-based” for future outcomes instead of “evidence-based” on the here and now.

### SUMMARY

The disclosed device is unique when compared with other known devices and solutions because it provides a score and recommendations based on a Defensive and Offensive approach for managing personal finances based on a broader array of personal goals, user specific factors, and available products than is normally considered by similar applications. Further the inclusion of a financial score and a peer comparison provides better motivation for users to improve their personal finances.

The disclosed device is a unique improvement in personal finance analytics due to the presence of programming to: (1) provide a total score based on scores for contributing factors; and (2) provide recommendations based on at least one of user specific information, user goals, user's total score, and available products. This will give individuals tangible and useful evidence to increase the sense of urgency for planning.

### BRIEF DESCRIPTION OF DRAWINGS

FIG. 1 shows an example schematic view of a network.

FIG. 2 shows an example flow diagram of operations.

FIG. 3 shows an example flow diagram of communications between and operations performed by a first electronic device and a second electronic device.

FIGS. 4-8 show examples of the displays of the first electronic device displaying queries.

FIGS. 9-12 show examples of the displays of the first electronic device displaying output.

FIG. 13 shows an example of the display of the first electronic device displaying a reminder.

FIG. 14-20 shows an example of defensive contributing scoring.

FIG. 21-25 shows an example of offensive contributing scoring.

FIG. 26 shows an example of portfolio scoring.

FIG. 27 shows an example of legacy scoring.

FIG. 28-38 shows an example of the collection of user specific information.

FIG. 39 shows an example of presets.

### DETAILED DESCRIPTION

In the Summary above, in this Detailed Description, the claims below, and in the accompanying drawings, reference is made to particular features of the invention. It is to be understood that the disclosure of the invention in this specification includes all possible combinations of such particular features. For example, where a particular feature is disclosed in the context of a particular aspect or embodiment of the invention, or a particular claim, that feature can also be used—to the extent possible—in combination with and/or in the context of other particular aspects and embodiments of the invention, and in the invention generally.

The term “comprises” and grammatical equivalents thereof are used herein to mean that other components, ingredients, steps, etc. are optionally present. For example, an article “comprising” (or “which comprises”) components A, B, and C can consist of (i.e., contain only) components A, B, and C, or can contain not only components A, B, and C but also contain one or more other components.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

The term “at least” followed by a number is used herein to denote the start of a range including that number (which may be a range having an upper limit or no upper limit, depending on the variable being defined). For example, “at least 1” means 1 or more than 1. The term “at most” followed by a number is used herein to denote the end of a range, including that number (which may be a range having 1 or 0 as its lower limit, or a range having no lower limit, depending upon the variable being defined). For example, “at most 4” means 4 or less than 4, and “at most 40%” means 40% or less than 40%. When, in this specification, a range is given as “(a first number) to (a second number)” or “(a first number)-(a second number),” this means a range whose limits include both numbers. For example, “25 to 100” means a range whose lower limit is 25 and upper limit is 100 and includes both 25 and 100.

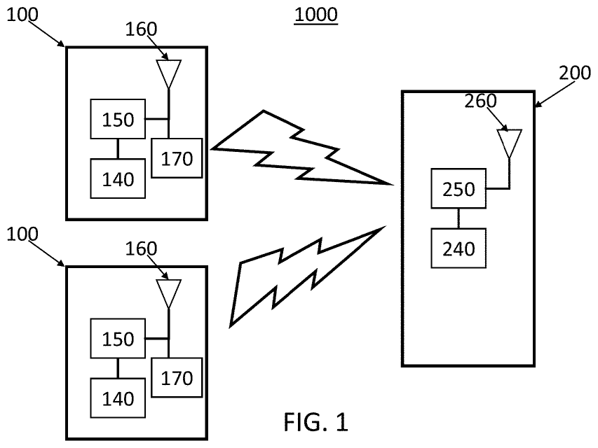

FIG. 1 shows an example schematic view of a network 1000. The network 1000 may include at least one first electronic device 100 and at least one second electronic device 200. The network may include various other electronic devices that convey information in the network, for example from the first electronic device 100 to the second electronic device 200. The first electronic device 100 may be a personal electronic device such as a personal computer, cell phone, etc. The first electronic device may include a memory 140, a processor 150, and a transceiver 160. The memory 140 may include volatile and non-volatile memory.

The memory 140 may contain therein instructions for operating the first electronic device 100 and other stored information. The memory 140 may be a non-transitory processor readable medium holding instructions thereon for implementing the features described below as part of an application, program, or other implementation of electronic instructions using electronic devices. The processor 150 may include one or more processing devices such as a central processing unit, controller, or other similar hardware. The processor 150 may be configured to execute the instructions stored in the memory 140 and control the first electronic device 100.

The transceiver 160 may include one or more communication interfaces for wireless communications, wired communications, fiber optic communications, etc. The transceiver 160 may operate based on commands received from the processor 150 and be configured to communicate electronically with other electronic devices in the network 1000. The first electronic device 100 may also include a display 170. The display 170 may be configured to display images and information for a user based on commands received from the processor 150.

The second electronic device 200 may include one or more computers, servers, or other similar devices. The second electronic device 200 may include a memory 240, a processor 250, and a transceiver 260. The memory 240 may include volatile and non-volatile memory. The memory 240 may contain therein processor readable instructions for operating the second electronic device, operating a software platform, and other stored information.

The memory 240 may be a non-transitory processor readable medium holding instructions thereon for implementing the features described below as part of an application, program, or other implementation of electronic instructions using electronic devices. The processor 250 may include one or more processing devices such as a central processing unit, controller, or other similar hardware. The processor 250 may be configured to execute the instructions stored in the memory 240 and control the second electronic device 200. The transceiver 260 may include one or more communication interfaces for wireless communications, wired communications, fiber optic communications, etc. The transceiver 260 may operate based on commands received from the processor 250 and be configured to communicate electronically with other electronic devices in the network 1000.

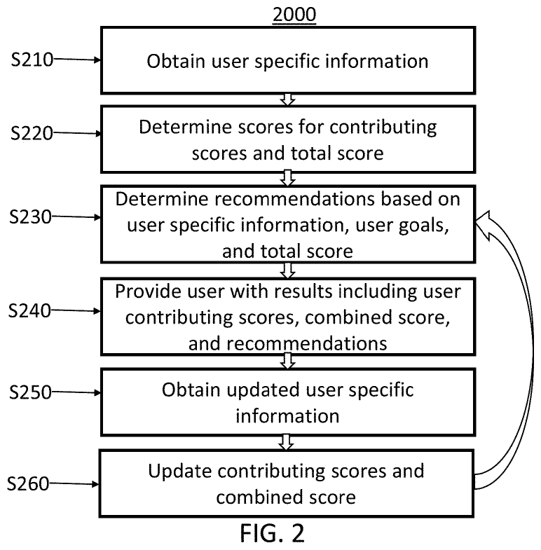

FIG. 2 shows an example flow diagram 2000 of operations. The operations of the flow diagram 2000 may be performed by one or more electronic devices such as the second electronic device 200. The operations may be part of a program or application for financial scoring and financial planning. At S210, the second electronic device 200 may obtain user specific information. The user specific information may be obtained by receiving communications from a device associated with a user such as one of the first electronic devices 100. As will be discussed in greater detail below, the second electronic device 200 may send requests to the first electronic device 100 associated with the user and receive user specific information from the user in response to the requests via the first electronic device 100. Alternatively, the second electronic device 200 may obtain the user specific information directly from the user. As another alternative, the second electronic device 200 may obtain the user specific information from another electronic device or storage medium.

As will be described in greater detail below, the user specific information may include personal and familial information, estate planning information, assets and obligations information, insurance information, financial goal information, cash flow information, etc.

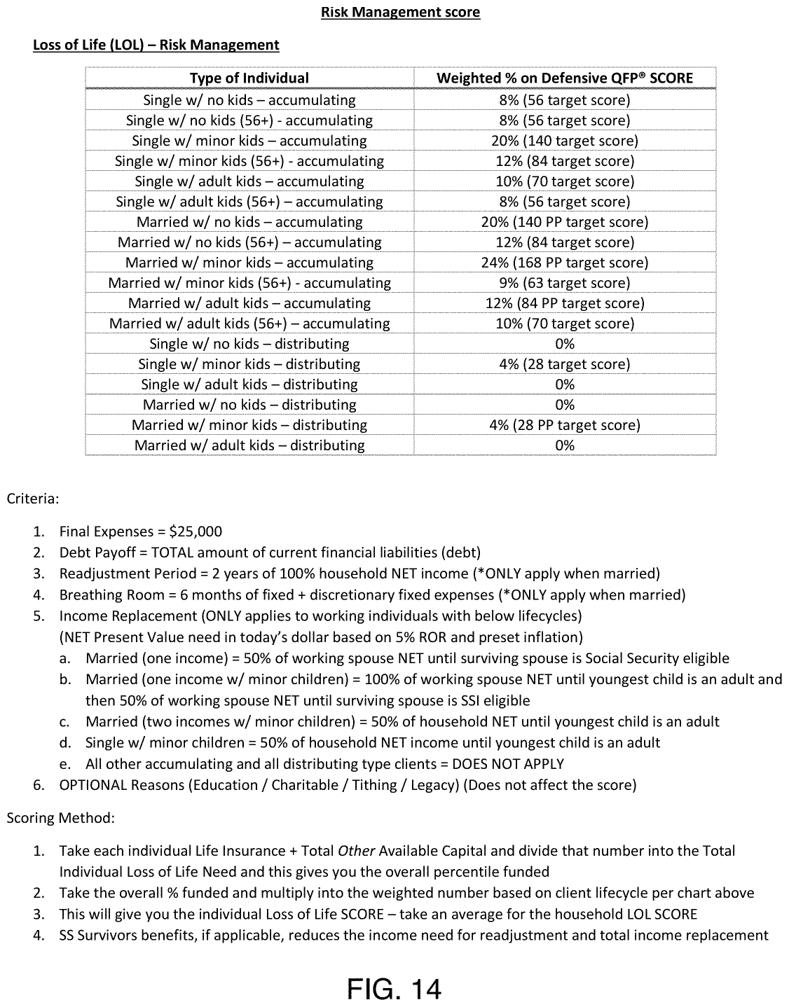

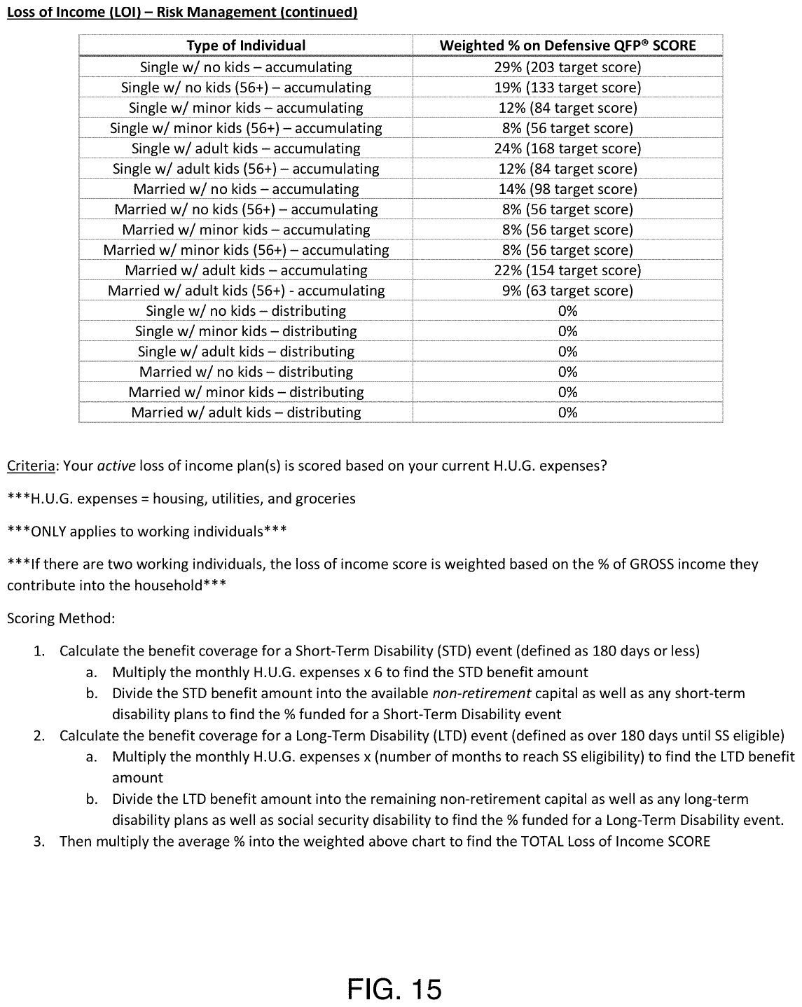

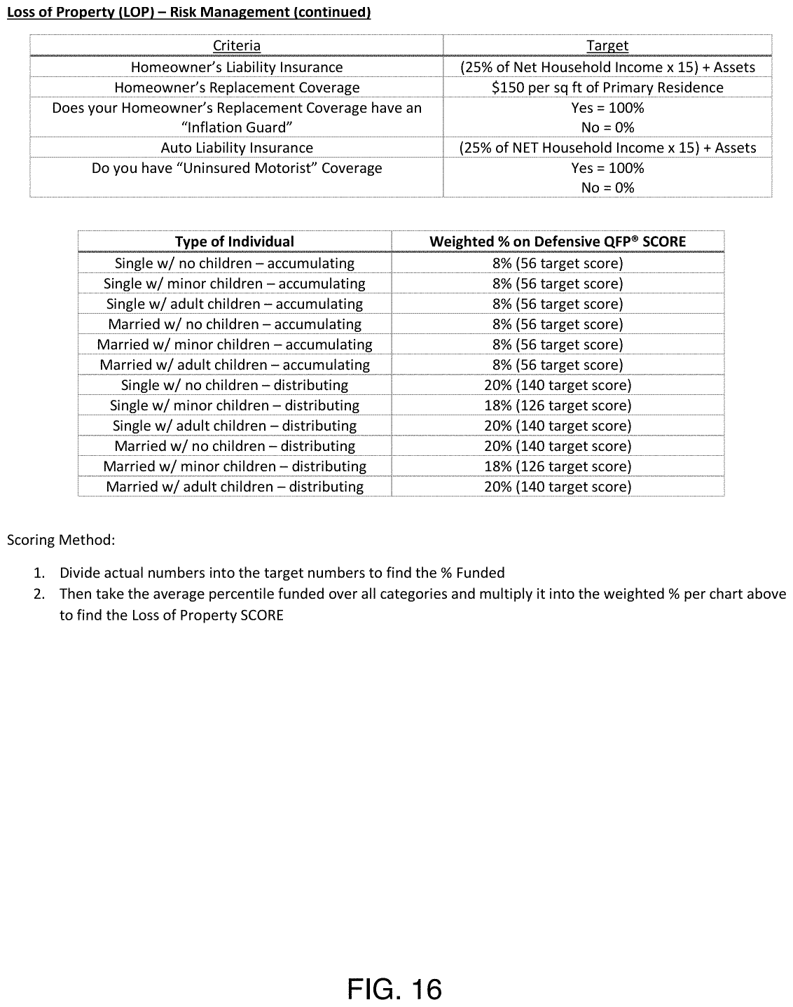

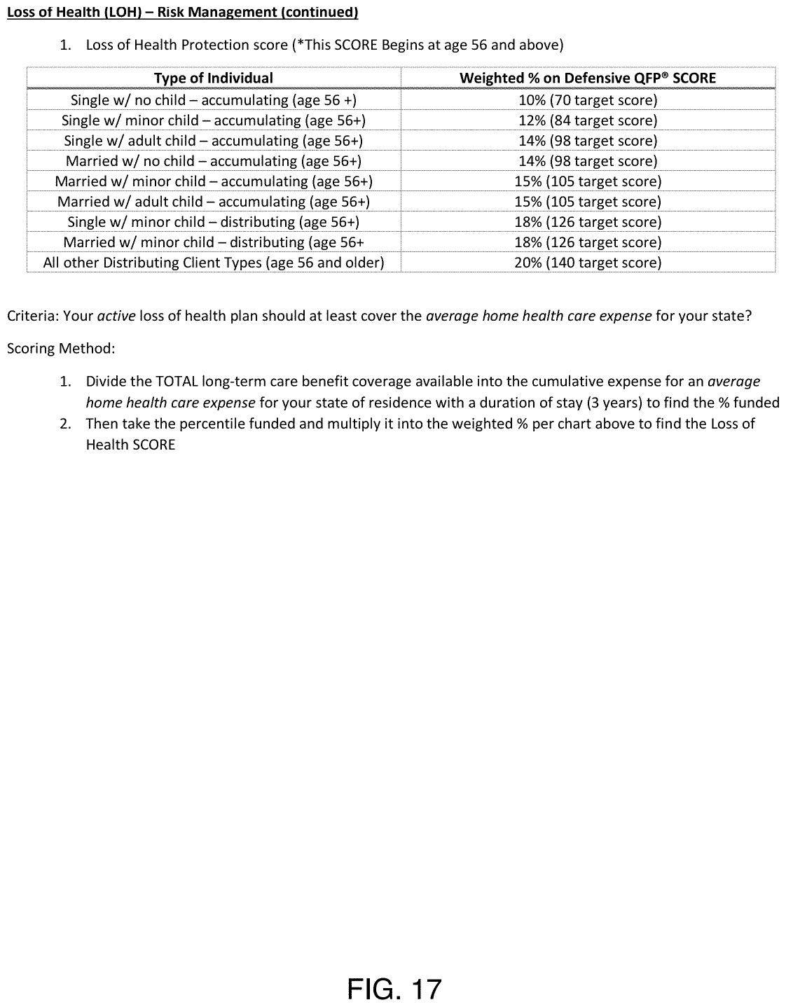

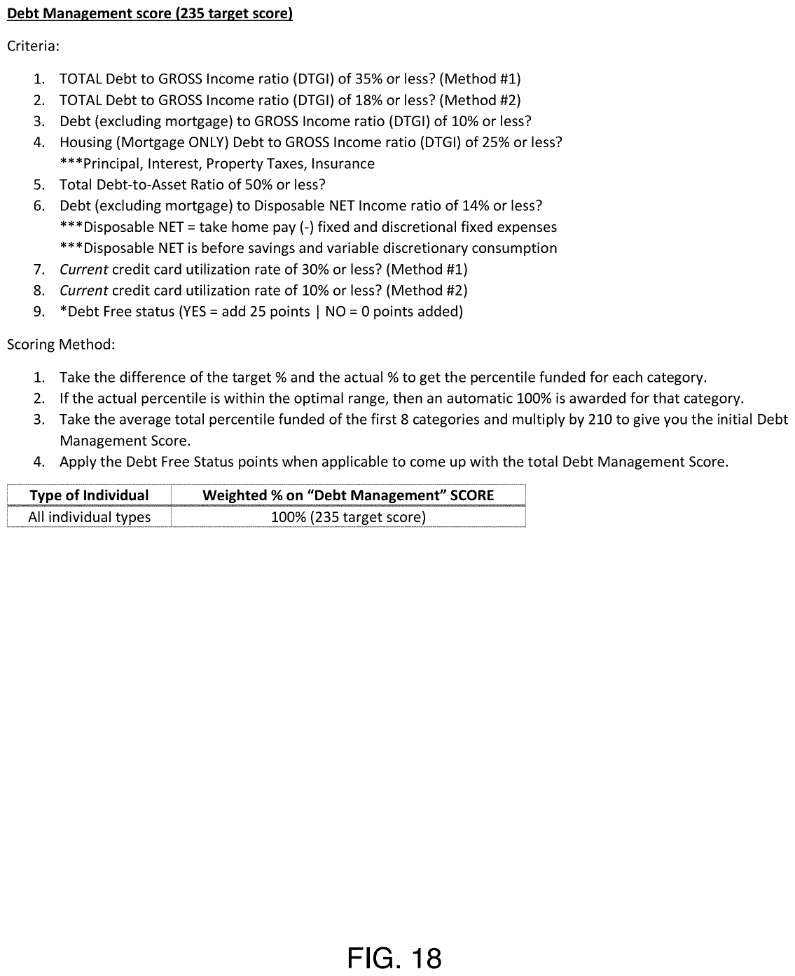

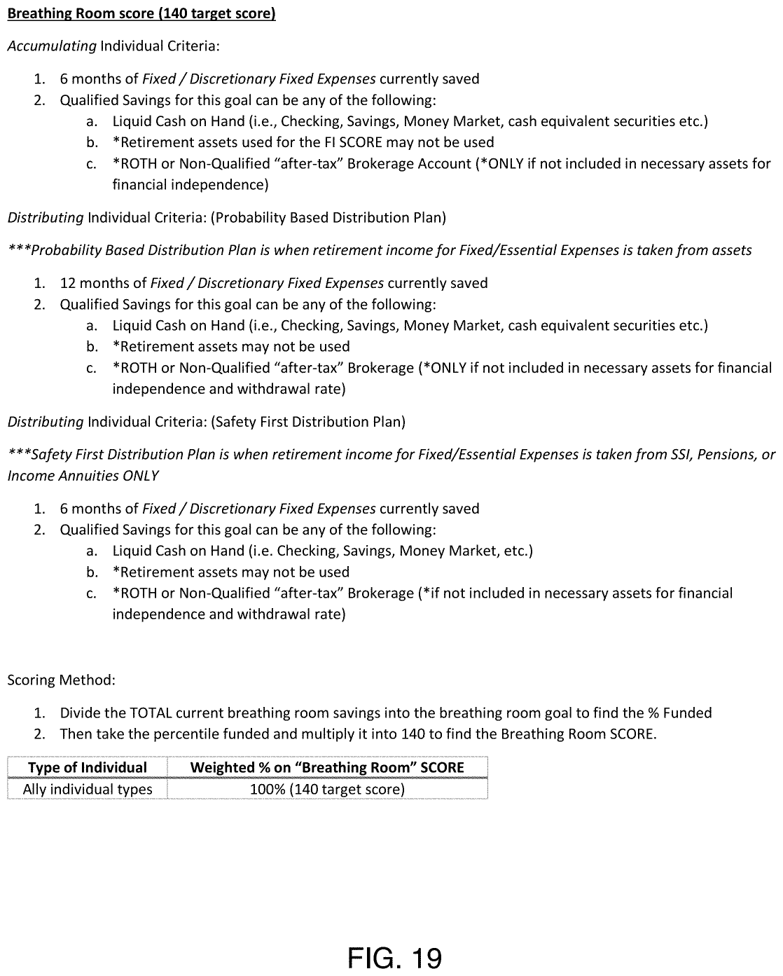

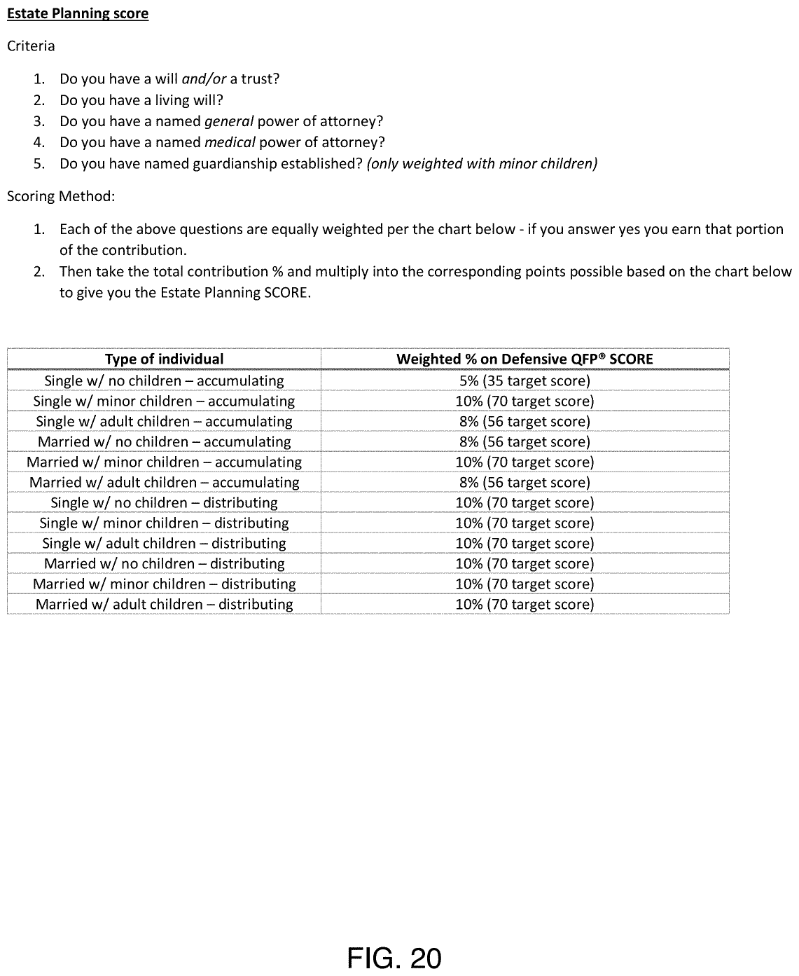

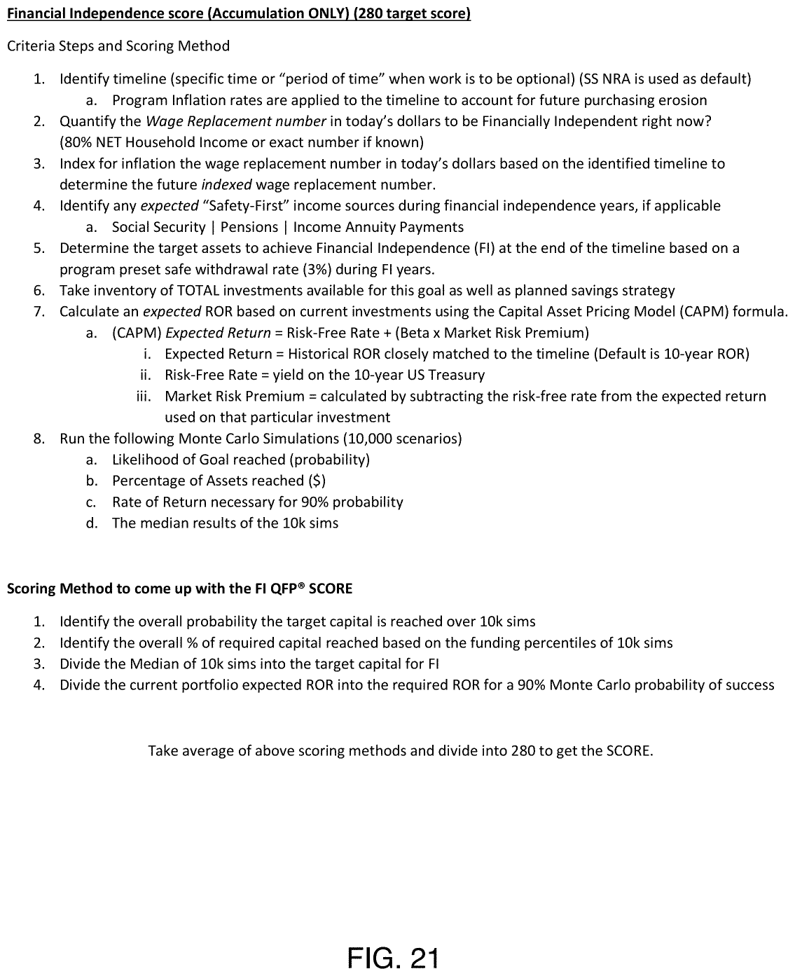

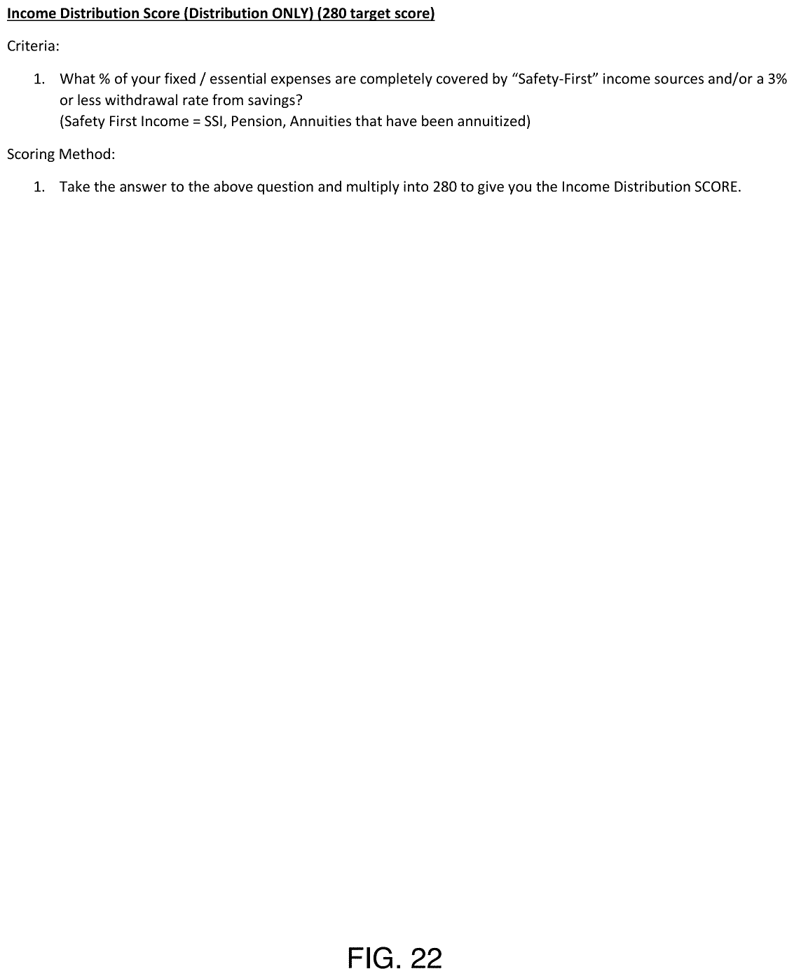

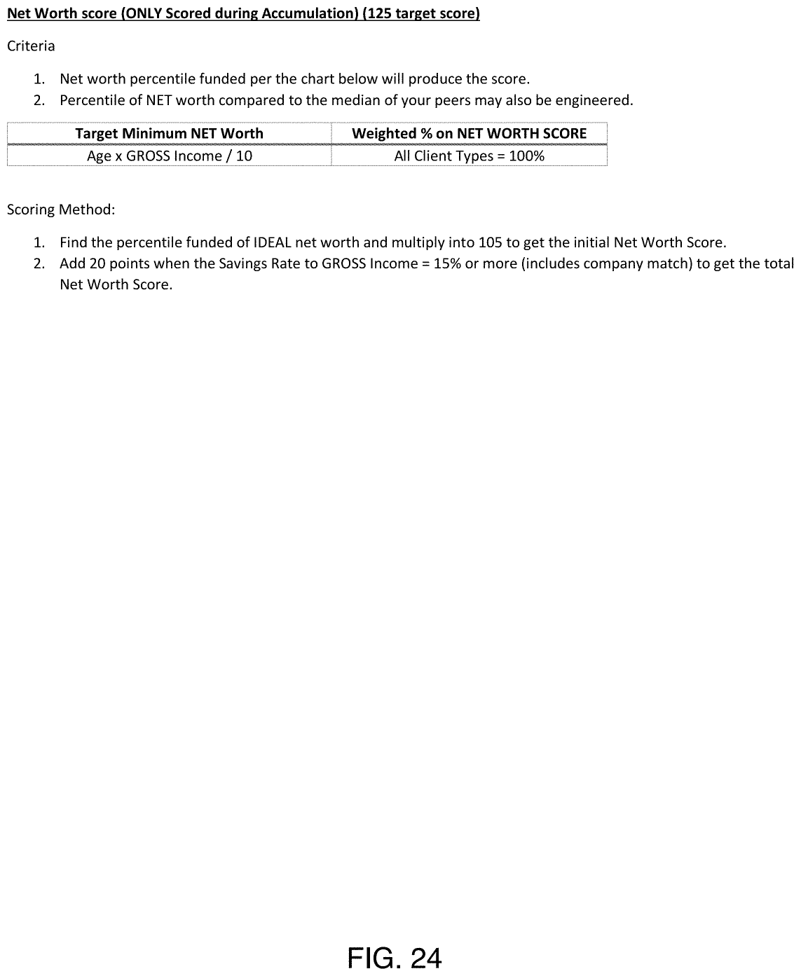

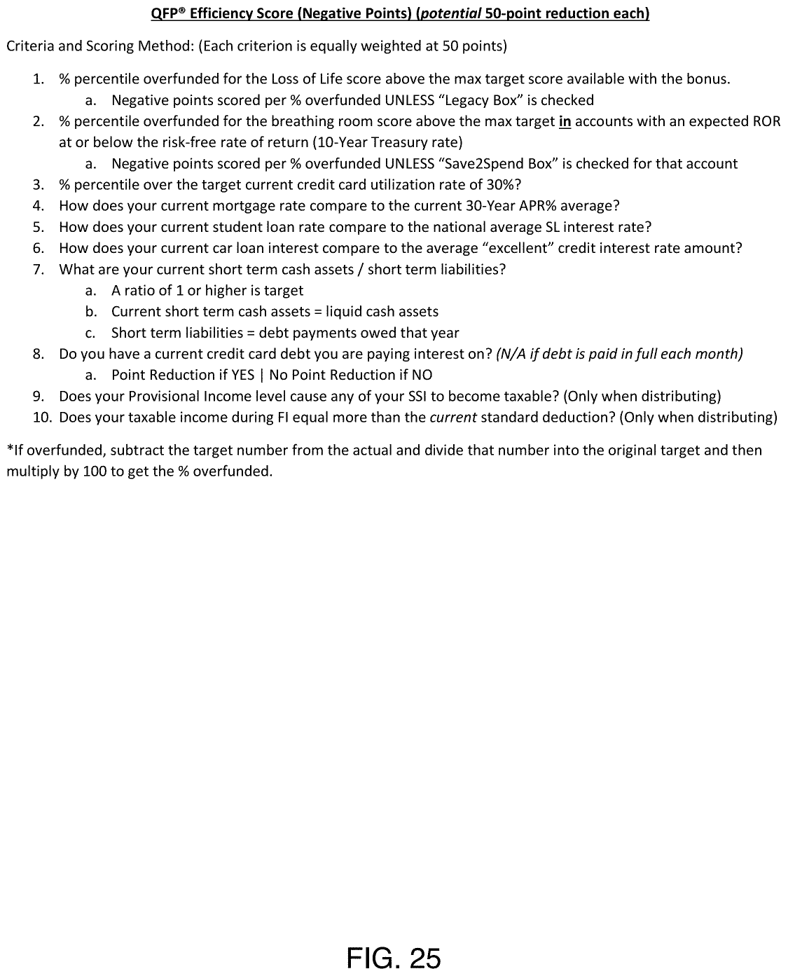

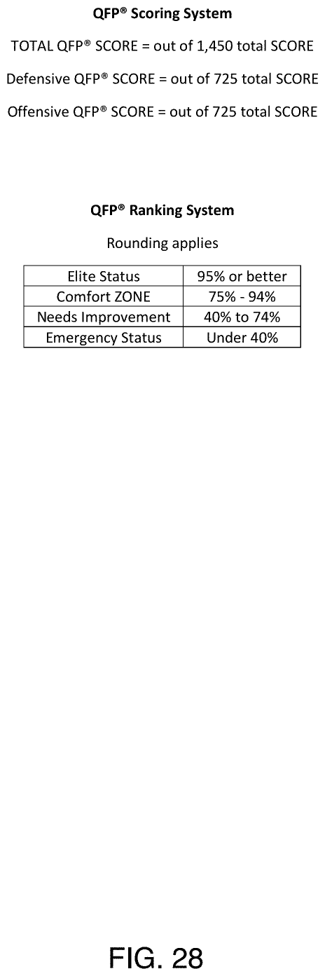

At S220, the device may determine scores for contributing scores and for a total score. The contributing scores and total score may be numerical scores (e.g., 1-100), grades (e.g., A-F), a level (e.g., excellent, satisfactory, or needs improvement), a comparison to a goal (e.g., average, above average, below average etc.), or any other useful metric. The total score may be a combination of the contributing scores, as illustrated in FIG. 28. In some embodiments, the contributing scores may be divided into several levels. The total score may be based on a first level of contributing scores (e.g., “defensive score” and an “offensive score”). The first level of contributing scores may be determined based on a second level of contributing scores (e.g., the offensive score may be determined based on financial independence score, income distribution score, cash flow score, net worth score, and money efficiency score, as illustrated in FIGS. 21-24 and the defensive score may be determined based on the risk management score, debt management score, breathing room score, and estate planning score as illustrated in FIGS. 14-20).

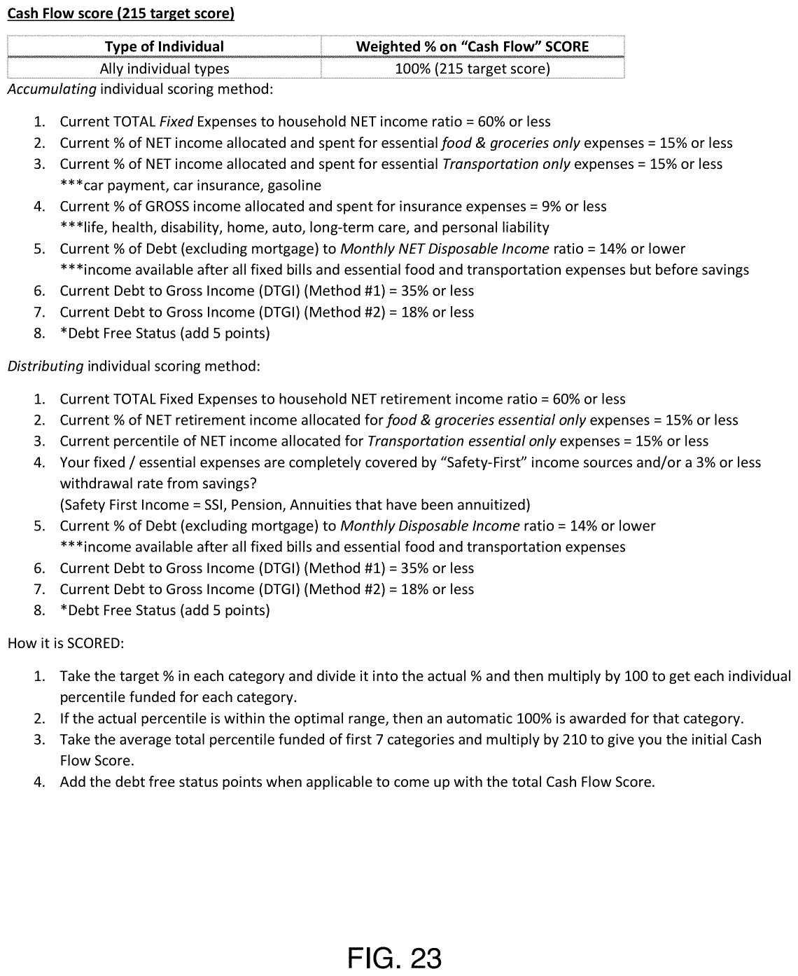

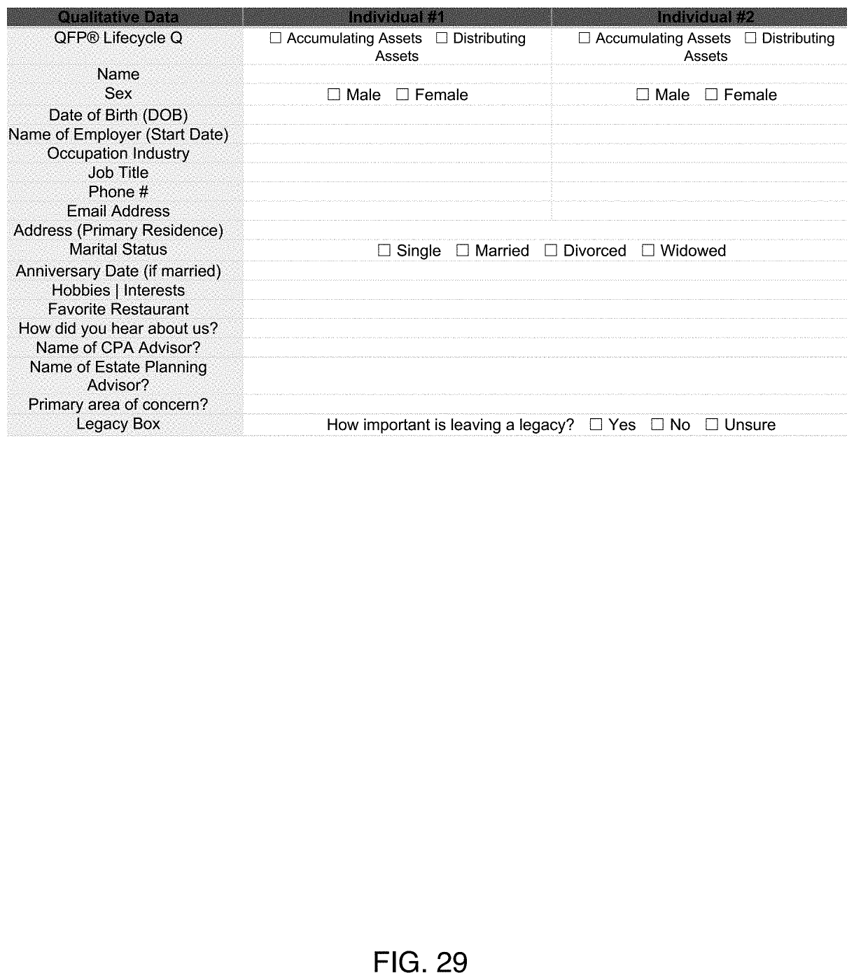

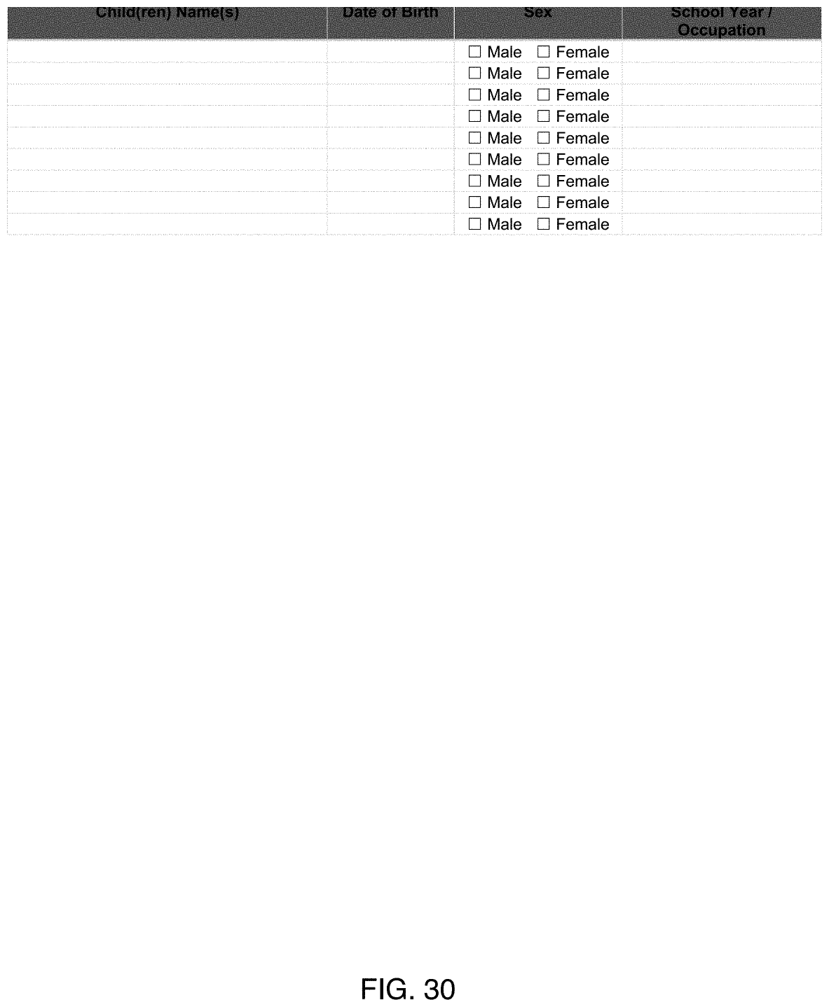

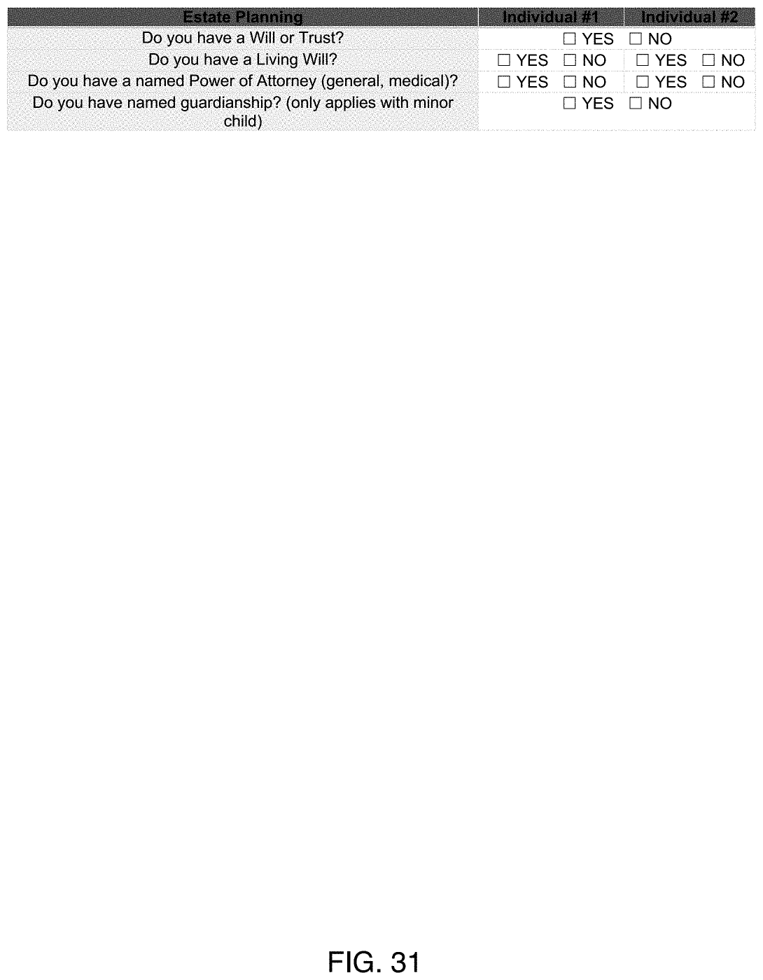

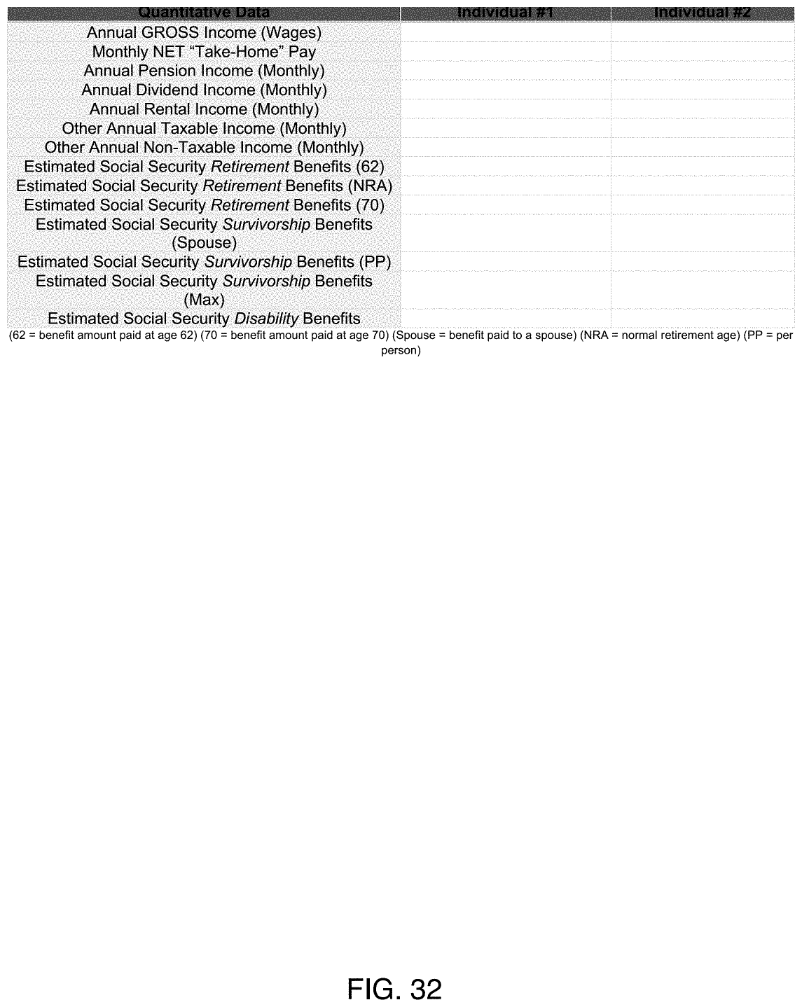

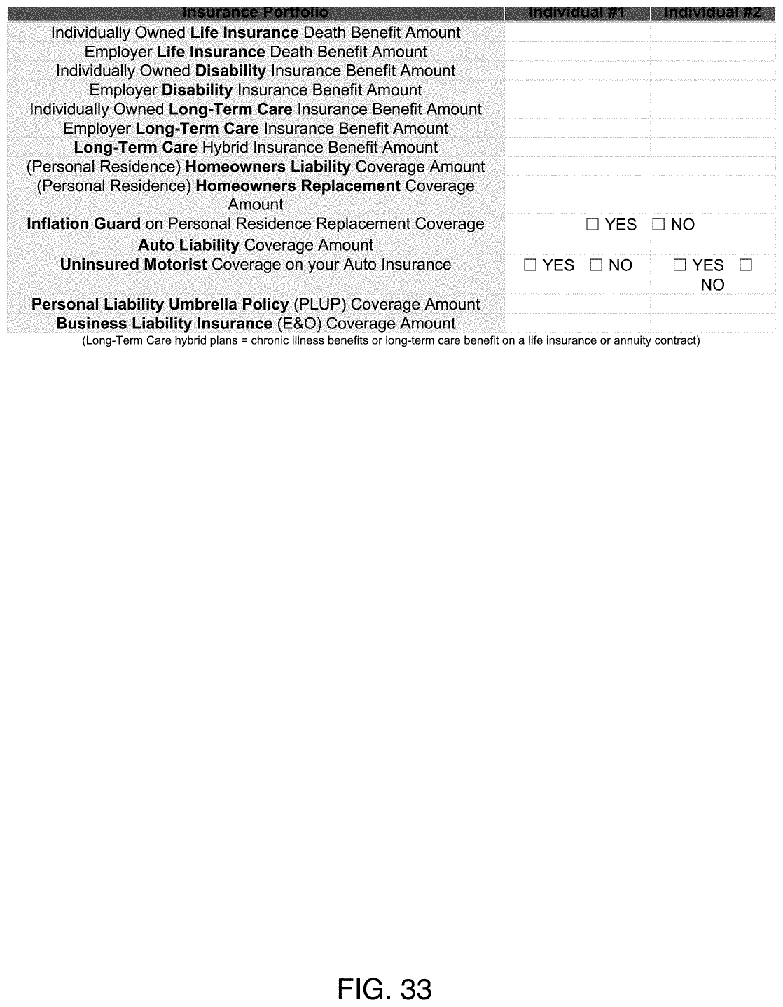

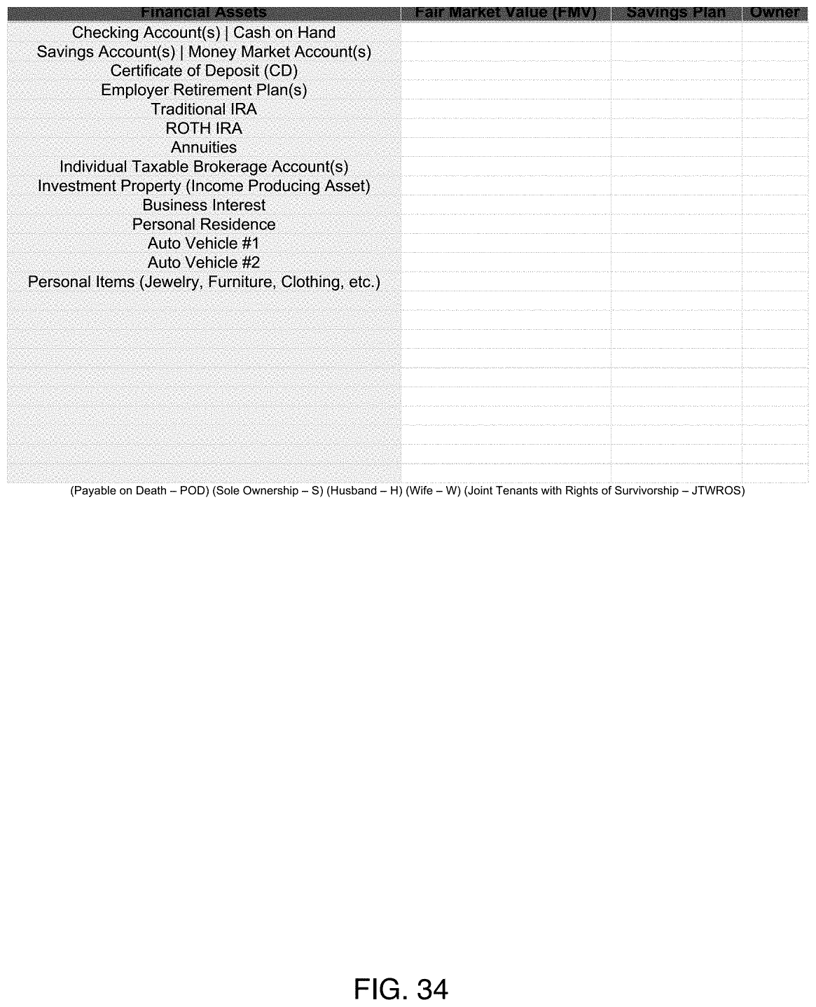

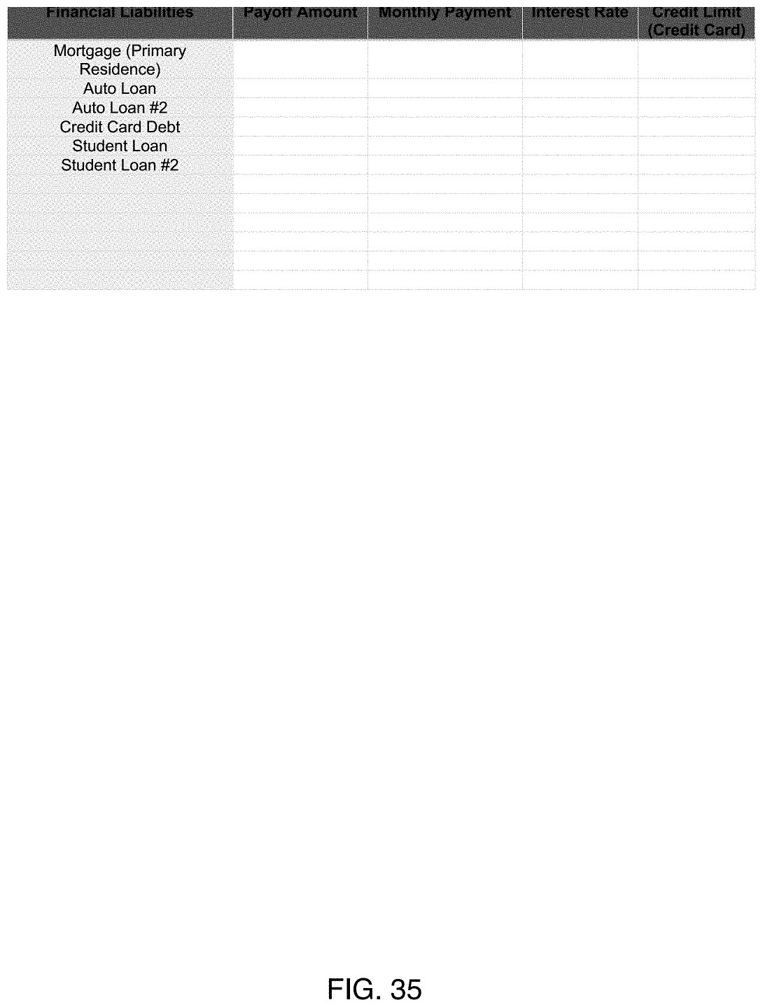

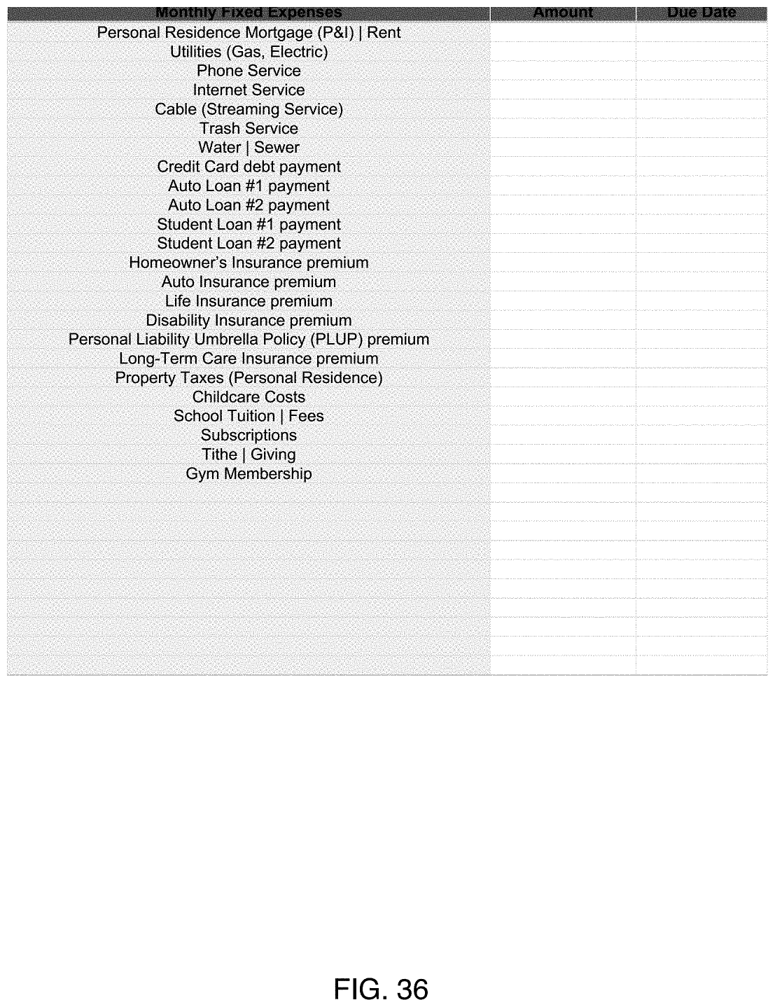

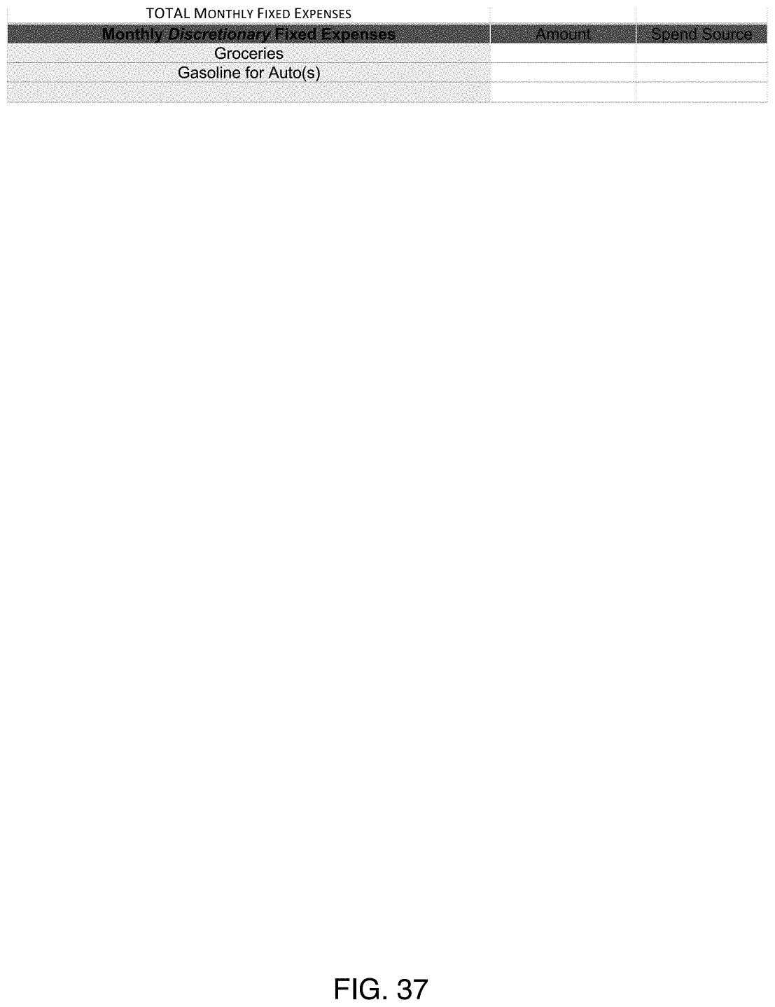

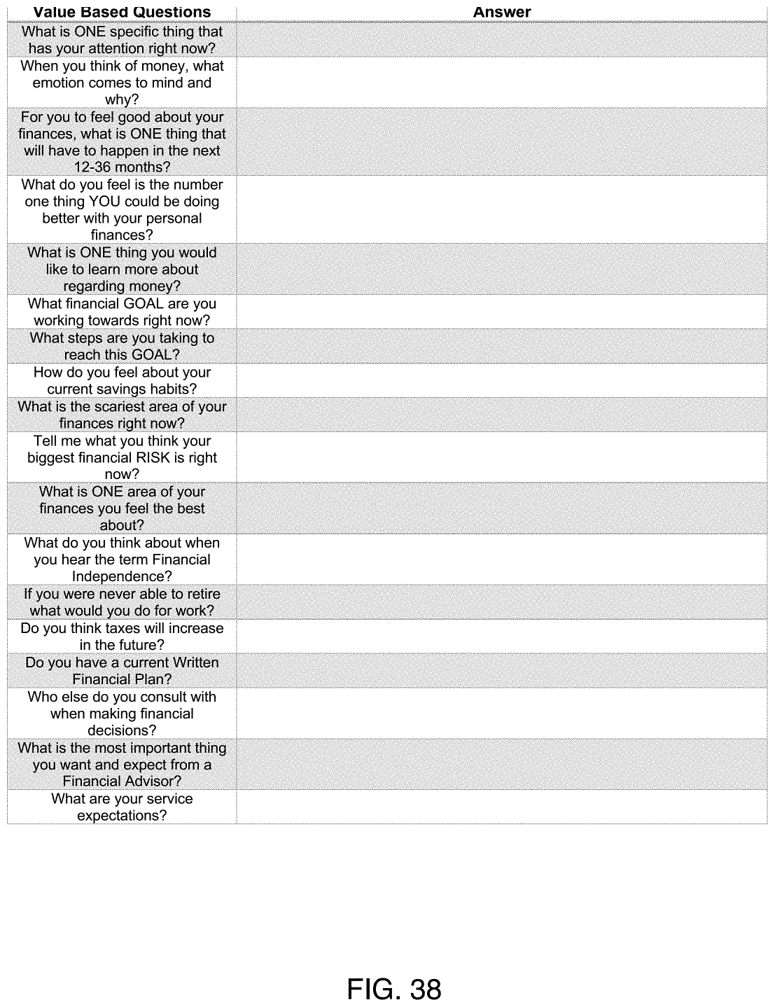

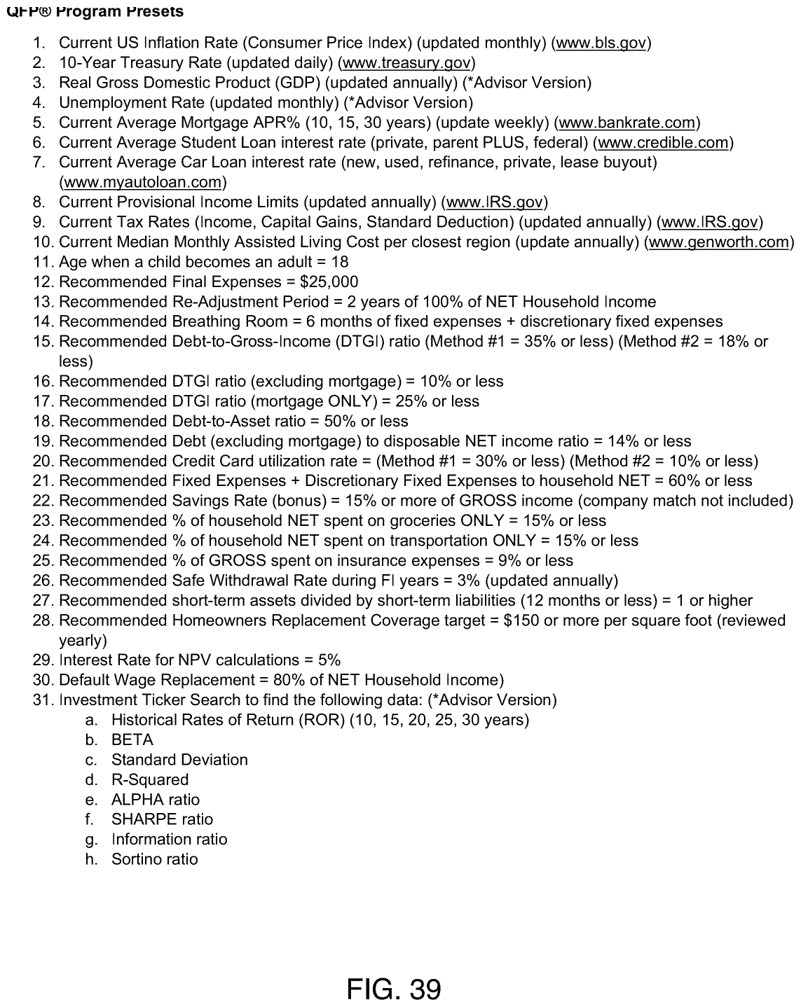

The second level of contributing scores may be determined based on the user specific information that may be inputted into system as illustrated in FIG. 29-38 and presets. For example, a financial independence score may be based on comparing the user's passive income to obligations the user has and the cost of living of the area where the user lives. Other factors such as liquid assets and net worth may also factor into the financial independence score. As another example, a cash flow score may be determined by comparing the income of the user to obligations and other expenses the user has and determining if the user's cash flow allows the user to meet their financial goals, as illustrated in FIG. 23. Thus, certain user specific information, such as income and goals, may be used to determine scores for several of the second level of contributing scores.

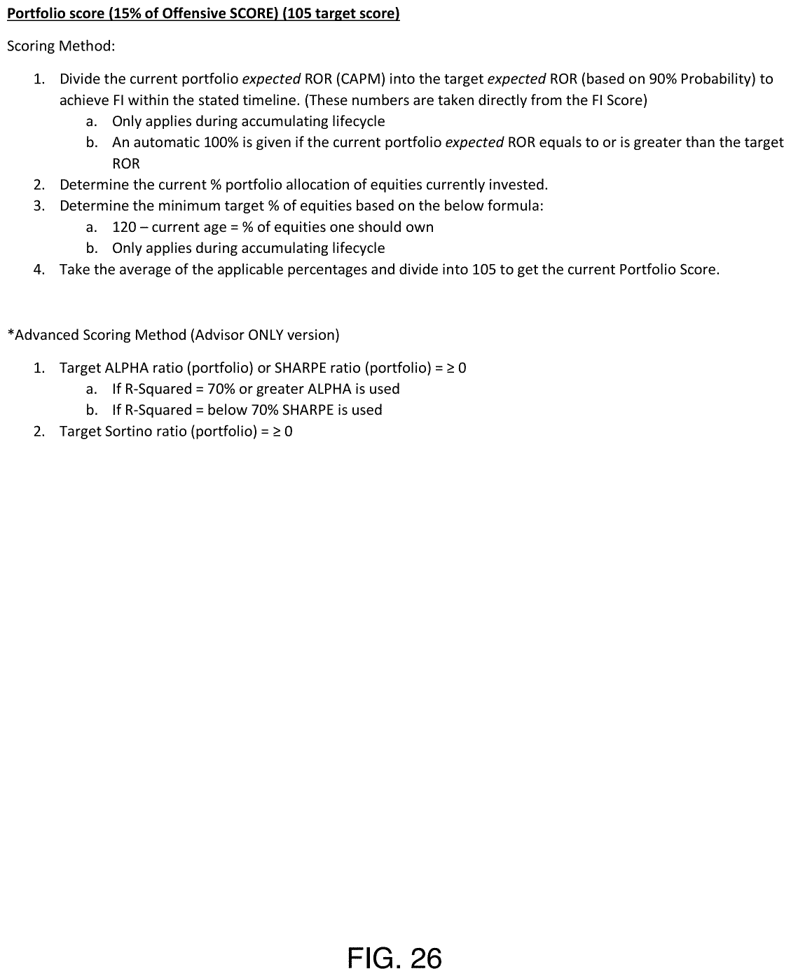

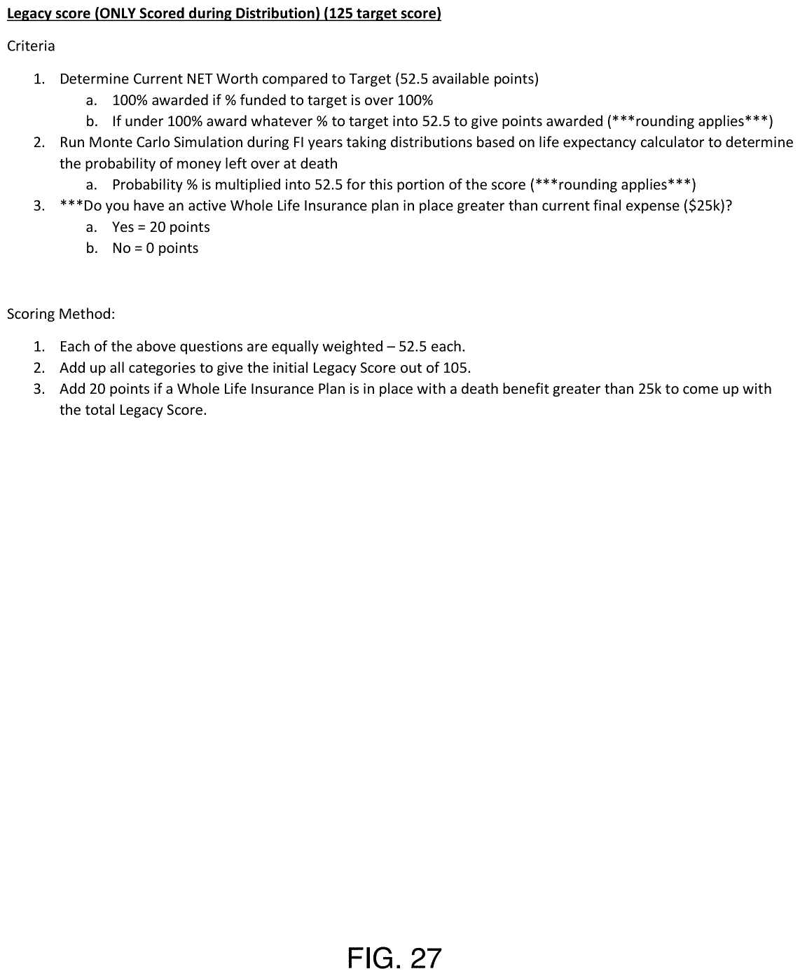

Different contributing scores, numbers of contributing scores, and weighting of the contributing scores may be used. The second level of contributing scores may be selected based on the situation or goals of the user. For example, a financial independence score may not be as relevant to a retired individual that has no active income. Thus, the financial independence score and cash flow score may be redundant. For a retired person, the financial independence score may be omitted and a higher weight may be given to a cash flow score. Also, a completely different contributing score, such as a portfolio balance score as illustrated in FIG. 26, and legacy score as illustrated in FIG. 27 that is more relevant to the user's condition may be used for a retired person. Accordingly, as part of the device determining scores for contributing scores, the device may determine which contributing scores to use and what weighting to give the contributing scores based on the user specific information.

The contributing scores may be added to arrive at a total score. For example, the total score may be out of 100 with the first level of contributing scores having a maximum value of 50 each being added together to arrive at the total score. Alternatively, the contributing scores may be weighted and then added to arrive at the total score. For example, the total score may be out of 100 with two contributing scores having a maximum value of 100 being weighted (50% each) to arrive at the total score. Other schemes and values may also be used to determine the total score. Similarly, the first level of contributing scores may be determined based on the second level of contributing scores, which may be added, or weighted to arrive at the score for the first level of contributing scores.

At S230, the second electronic device 200 may determine recommendations based on user specific information (e.g., user's goals, income, etc.), the contributing scores, and the total score. Recommendations may be based on the greatest potential for changing the contributing scores and total score. For example, if the cash flow score is low and the debt management score are low because a user has a car loan with a high interest rate causing high monthly payments on an asset that is depreciating in value, the application may recommend prioritizing paying off the car loan or selling the car and purchasing a more affordable vehicle. As another example, if the risk management score is lower because the user's home is in an area that may experience floods and the user's homeowner's insurance does not cover floods, the application may recommend obtaining homeowners insurance that covers flooding. Location may be determined from manually inputted information or via GPS.

Recommendations may be based on ease of implementation and costs as well. For example, even if relocation to an area with a lower cost of living may improve the user's total score the most, this recommendation may not be given if there are other viable suggestions that allow the user to remain in their current location and meet their financial goals due to the difficulty and general undesirability of moving. Recommendations may also be based on availability of information, for example, if the user has not provided a will to the application, the second electronic device 200, may determine to recommend providing a will so the estate planning score can be accurately determined. In further non-limiting embodiments, recommendations may be collected from third party databases and inputted into the system.

At S240, the second electronic device 200 may provide the user with results including contributing scores, total score, and recommendations. The user may be provided with the results in various manners including the second electronic device 200 providing the results to a first electronic device 100 associated with the user, by displaying results on a display to the user, or emailing results to an email address associated with the user.

At S250, the second electronic device may obtain updated user specific information. This may take various forms including monitoring credit sores and other user information from third party sources and sending reminders/requests for updated user specific information and new queries to the user (via email, an application on a first electronic device 100 associated with the user, display of the second electronic device 200, etc.) and receiving new responses to the new queries or receiving permission to access updated user information from a third party.

At S260, the second electronic device 200 may update contributing scores and the total score. The contributing scores and total scores may be updated based on the updated user specific information in the same way the contributing scores and total scores are determined at S220. After the contributing scores and total score are updated, the second electronic device 200 may return to S230 to determine new recommendations.

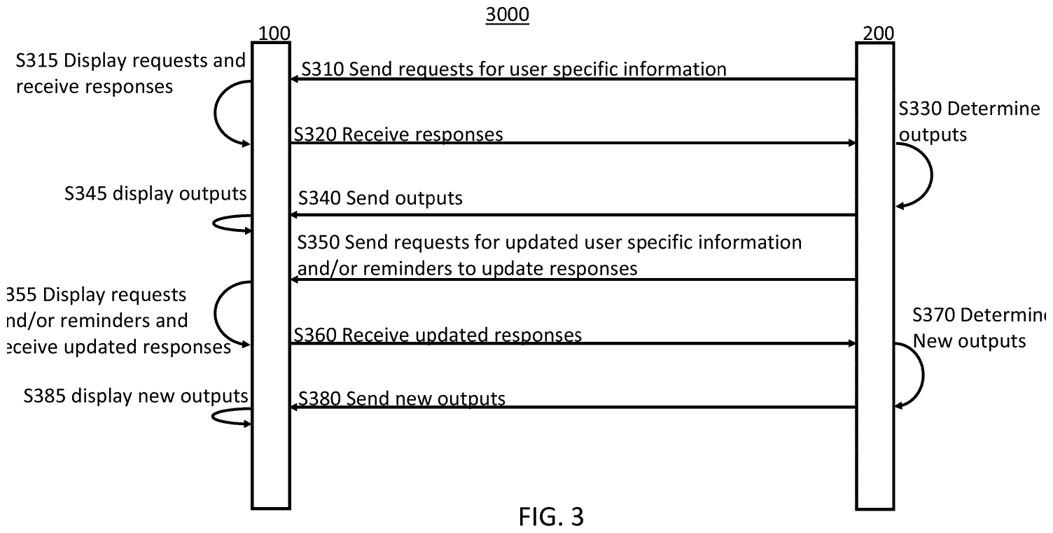

FIG. 3 shows an example flow diagram 3000 of communications between and operations performed by the first electronic device 100 and the second electronic device 200. The second electronic device 200 may be acting as a host device for the application and the first electronic device 100 may be acting as a user electronic device. At S310, the second electronic device 200 may send requests for user specific information to the first electronic device 100 and the first electronic device 100 may receive the requests. The requests for user specific information may take the form of questions to be answered, requests for documents, requests for permission to access information from third parties, etc. At S315, the first electronic device 100 may display the requests and receive user responses to the requests. The responses may include user specific information and permission to access user specific information. At S320, the first electronic device 100 may send the responses to the requests to the second electronic device 200 and the second electronic device 200 may receive the responses.

At S330, the second electronic device 200 may determine outputs. The outputs may include the results (e.g., contributing factor scores, total scores, and recommendations). At S340, the second electronic device 200 may send the outputs to the first electronic device 100 and the first electronic device 100 may receive the outputs. At S345, the first electronic device 100 may display the outputs.

At S350, the second electronic device 200 may send new requests for updated user specific information and/or reminders to update responses. Some user information, such as name, may not be requested to be updated, other information may be requested to be updated such as income, and monthly expenditures may be updated monthly. Still other information may be requested to be updated yearly, such as insurance policies and contact information. Some updated user specific information may be requested based on updates to other user specific information.

For example, if the user updates their address, the application may request an updated homeowner's insurance policy. At S355, the first electronic device 100 may display the new requests for updated responses and/or the reminders to update responses and receive updated responses in response to the updated requests and/or the reminders to update responses. At S360, the first electronic device 100 may send the updated responses to the second electronic device 200 and the second electronic device 200 may receive the updated responses. The received updated responses may include updated user specific information and/or permission to access the user specific information from a third party.

At S370, the second electronic device 200 may determine new outputs based on the new responses. The new outputs may include the results (e.g., contributing scores, total scores, and recommendations). At S380, the second electronic device 200 may send the new outputs to the first electronic device 100 and the first electronic device 100 may receive the new outputs. At S385, the first electronic device 100 may display the new outputs. Accordingly, the second electronic device 200 may perform the operations of flow diagram 2000 by communicating with the first electronic device 100 and performing the operations of flow diagram 3000.

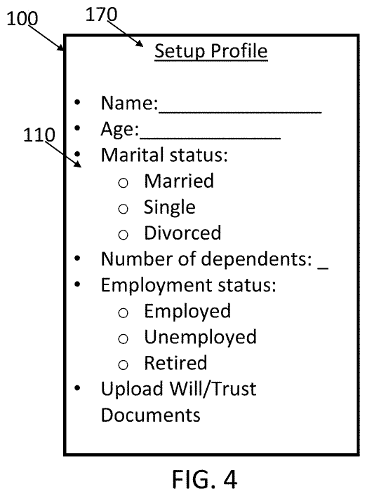

FIGS. 4-8 show examples of the displays 170 of the first electronic device 100 displaying requests for user specific information 110. FIG. 4 shows an example of the display 170 of the first electronic device 100 displaying requests for user specific information 110 related to a user's personal information, familial information, and will/trust information. The application may request personal information including name and age (or date of birth), familial information including marital status, number of dependents, employment status (e.g., employed, unemployed, and retired) and will/trust information including requests to upload will/trust documents. The user may respond by entering information into blanks, selecting options, or uploading documents.

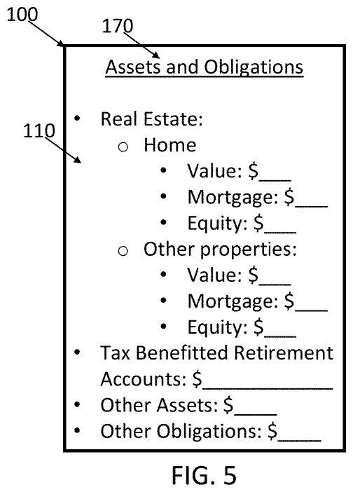

FIG. 5 shows an example of the display 170 of the first electronic device 100 displaying requests for user specific information 110 related to assets and obligations. The application may request that the user enter information related to any real estate that the user owns or has an interest in. The application may request values of the properties, mortgage amounts, and equity value in the property. The application may differentiate between home or primary residence and other property. The application may request information related to tax benefitted retirement accounts and other assets. The application may also request information related to other financial obligations the user may have such as car loans, child support payments, credit card debt, etc.

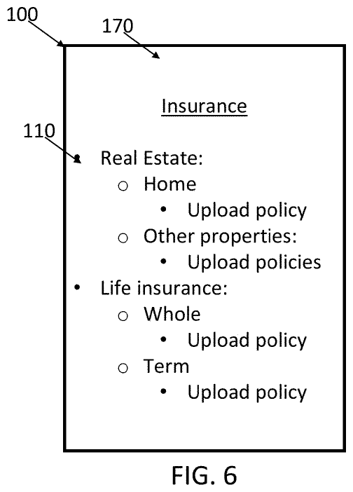

FIG. 6 shows an example of the display 170 of the first electronic device 100 displaying requests for user specific information 110 related to insurance. The application may request information regarding insurance on real estate, such as homeowner's insurance or other property insurance, car insurance, life insurance, boat insurance, business insurance, malpractice insurance, etc. The types of insurance the user is asked to provide information regarding insurance may be related to responses to the asset information. For example, if a home is listed as an asset, then the application may request insurance information related to that property.

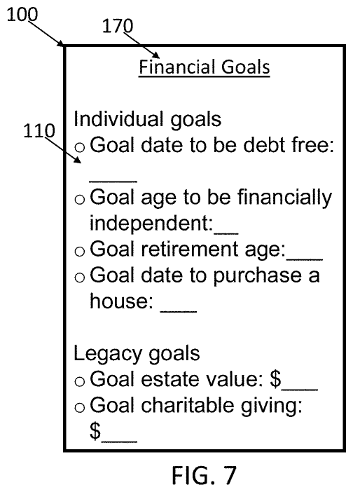

FIG. 7 shows an example of the display 170 of the first electronic device 100 displaying requests for user specific information 110 related to financial goals. The financial goals may include individual goals and legacy goals. The individual goals may include a goal date to be debt free, a goal age to be financially independent, a goal age to retire, a goal date to purchase a house, etc. The legacy goals may include a goal estate value, goal charitable giving by the user's estate, etc.

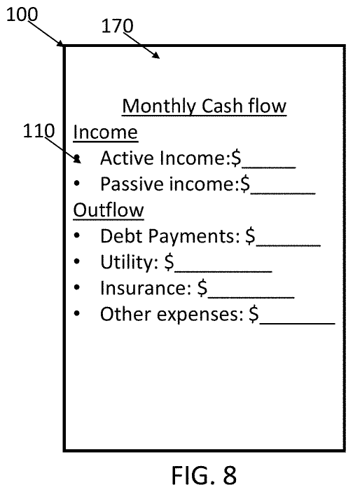

FIG. 8 shows an example of the display 170 of the first electronic device 100 displaying requests for user specific information 110 related to monthly cash flow. The application may request information related to monthly income and monthly outflow. The application may request information related to monthly active income, monthly passive income, etc. The application may request information related to monthly debt payments, monthly utility bills, monthly insurance premiums, and other expenses (food, gas, etc.).

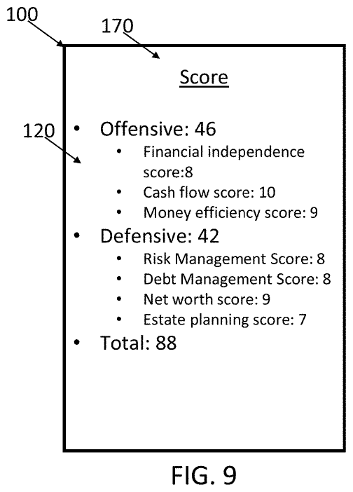

FIGS. 9-12 show examples of the displays 170 of the first electronic device 100 displaying output 120. FIG. 9 shows an example of the display 170 of the first electronic device 100 displaying score outputs 120. The score output may include a total score and contributing scores as illustrated in FIG. 28. For example, the contributing scores may include first contributing scores. The first contributing scores may include an offensive score and a defensive score. The score of the first contributing scores may be determined based on second contributing scores. The second contributing scores for the offensive score may be financial independence score, cash flow score, net worth score, and money efficiency score (additional or other second contributing scores may be used as well). The second contributing scores for the defensive score may include risk management score, debt management score, breathing room score, and estate planning score.

The offensive score may be based generally on factors that relate primarily to the user's ability to generate wealth and manage income. The defensive score may be based generally on the user's ability to manage risk and maintain wealth. Each of the offensive and defensive scores may be based on the user's goals. For example, if the user has a goal to have a net worth of $2 million, the offensive score will be based on the ability of the user to generate and manage a net worth of $2 million and the defensive score will be based on the user's ability to maintain the wealth and manage risk while generating the wealth. This is reflected in how the secondary contributing scores are calculated. For example, the cash flow score may be determined based on the user being able to save enough money to obtain the desired net worth by a desired time. The net worth score may also be determined by the user being on track to obtain the desired net worth by the desired time based on current investments, predicted returns, and current cash flow.

In one embodiment, the secondary contributing scores may be on a scale of 1-10, the primary contributing scores may be on a scale of 1-50, and the total score may be on a scale of 1-100. The total score may be determined by adding the first contributing scores. The first contributing scores may be calculated by weighting the second contributing scores of the first contributing score. The second contributing scores may be determined by determining if the user can obtain the user's goals based on user specific information related to the second contributing score. For example, the financial independence score may be determined by determining if the user's predicted passive income at retirement age will be able to allow the user to retire at the goal retirement age.

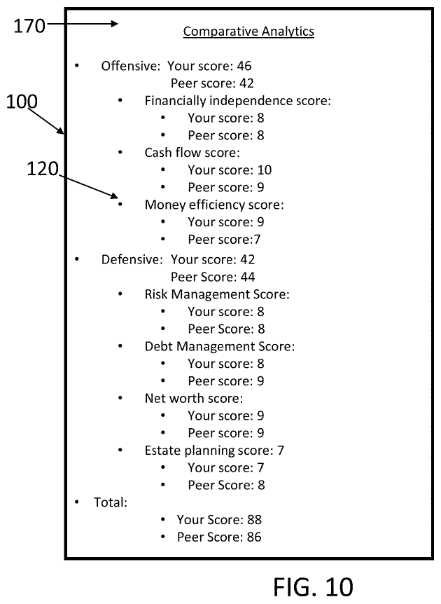

FIG. 10 shows an example of the display 170 of the first electronic device 100 displaying comparative analytics output 120. The comparative analytic output may show the user's scores and average peer scores for total score, first contributing scores, and second contributing scores. The peer score may be an average score for other users of the application with at least one of similar ages, similar goals, or similar income. Alternatively, several peer scores may be displayed. For example, a peer score for people with a similar age, a peer score for people with similar goals, and a peer score for people with a similar income. As another alternative, the peer score may be based on survey data or other data that is not exclusively from other users of the application.

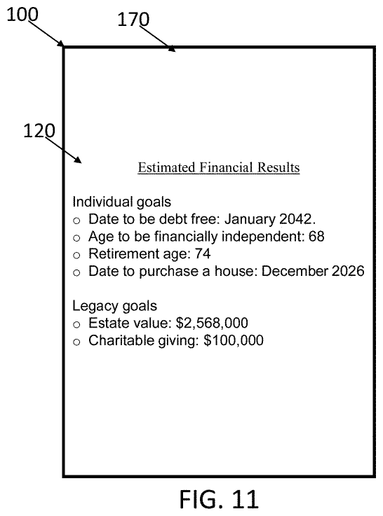

FIG. 11 shows an example of the display 170 of the first electronic device 100 displaying output 120 including estimated financial results. The estimated financial results may be based on the user's goals, for example for each goal, the result may show if the user is on track to achieve that goal. For example, the results may include an estimated date the user will be debt free, an estimated age when the user will be financially independent, an estimated retirement age, an estimated date when the user will have enough money to purchase a house, an estimated estate value, and an estimated charitable giving that the user's estate will be able to make.

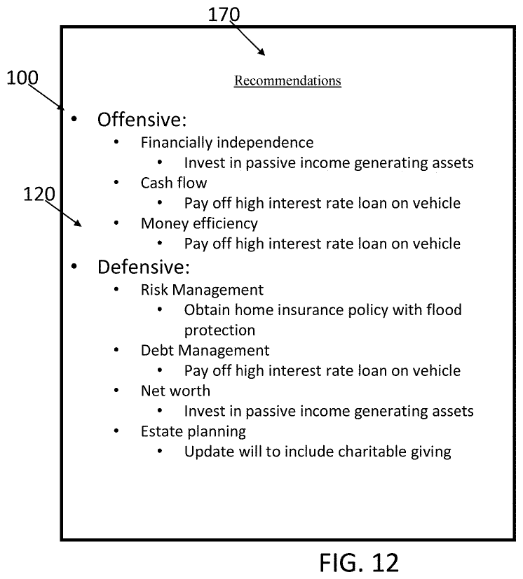

FIG. 12 shows an example of the display 170 of the first electronic device 100 displaying output 120 including recommendations. The recommendations may be based on general advice or may be directed to fulfilling a specific goal that the user has. For example, for a user to gain financial independence by a goal date and obtain a goal net worth, the user may be given a general recommendation to invest in passive income generating assets. As another example, a specific asset type or asset may be recommended, such as long-term corporate bonds, or stock in a particular company that traditionally pays high dividends. The recommendations may also include recommendations for specific tasks to be performed, such as in order to improve cash flow, money efficiency, and debt management, the user may be recommended to pay off a high interest rate loan that the user has on a vehicle.

The recommendations may also include specific actions to be taken, such as obtaining a home insurance policy with flood protection. In some embodiments, particular products such as an insurance plan from a particular insurer may be recommended. Further, the results may include actions for the user to take to improve estate planning, such as a recommendation to update the user's will to include charitable giving if the user has a goal for the user's estate to give a certain amount. The recommendations may be listed with the contributing scores they will improve. Alternatively, the recommendations may be listed in order of greatest effect on the total score or in some other order.

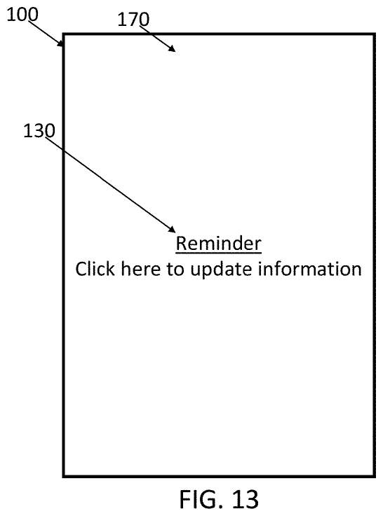

FIG. 13 shows an example of the display 170 of the first electronic device 100 displaying a reminder 130. The reminder 130 may include a link to an application or web page where the user may update user specific information or otherwise respond to requests from the application. The reminder 130 may also include an explanation as to what updates are needed or why the reminder is being sent.

Advantageously, the application provides a system that may assist a user in knowing how to achieve the user's financial goals. This may be achieved by collecting user specific information and providing recommendations based on the user specific information. Also, the application is a significant improvement over other applications because the application provides a score that is broken down into component parts that the user can more easily understand. This helps a user to understand the importance of the recommendations and also helps motivate the user to implement the recommendations. The inclusion of comparative metrics such as peer comparison of scores also helps to motivate users to take action in order to keep up with their peers without intruding on the privacy of the users.

Further advantageously, because the contributing scores may be determined based on the user's situation and goals, the application can provide a more tailored score and more tailored recommendations for the user rather than the cookie cutter advice normally given to users of similar products.

Accordingly, the present description provides for various embodiments for an application implemented on an electronic device for managing personal finances. Many uses and advantages are offered by the application as described above in one or more non-limiting embodiments in the present description.

The corresponding structures, materials, acts, and equivalents of any means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention.

The embodiments were chosen and described in order to best explain the principles of the invention and the practical application, and to enable others of ordinary skill in the art to understand the invention for various embodiments with various modifications as are suited to the particular use contemplated. The present invention, according to one or more embodiments described in the present description, may be practiced with modification and alteration within the spirit and scope of the appended claims. Thus, the description is to be regarded as illustrative instead of restrictive of the present invention.

What is claimed is:

1. A device comprising:
one or more memories configured to store computer readable instructions thereon; and
one or more processors configured to implement the computer readable instructions to:
obtain user specific information relevant to a user's finances;
determine which contributing scores to use to obtain a total score based on the user specific information;
determine values of the contributing scores and the total score based on the user specific information;
determine one or more recommendations based on the user specific information and the contributing scores; and
provide a user with the contributing scores, the total score, and the one or more recommendations.

2. The device of claim 1, wherein the user specific information includes user goals and the one or more processors are further configured to determine which of the contributing scores to use to obtain the total score based on the user goals.

3. The device of claim 1, wherein the user specific information includes user employment status and the one or more processors is further configured to determine which contributing scores to use to obtain the total score based on the user employment status.

4. The device of claim 1, wherein the contributing scores are made of an offensive score and a defensive score, the offensive score defining an ability to generate wealth and manage income, the defensive score defining an ability to manage risk and maintain wealth.

5. The device of claim 4, wherein the offensive score is determined in response to a financial independence score, income distribution score, cash flow score, net worth score, and money efficiency score.

6. The device of claim 4, wherein the defensive score is determined in response to a risk management score, a debt management score, a breathing room score, and an estate planning score.

7. The device of claim 1, wherein the risk management score is made of a loss of life score, a loss of property score, a loss of income score, and a loss of health score.

8. The device of claim 1, wherein a total loss of life score is calculated by taking each individual life insurance and total other available capital and then divided into a total individual loss of life need which gives an overall percentile funded, wherein the overall percentile funded is multiplied into a weighted number based on client lifecycle to give an individual loss of life score.

9. The device of claim 8, wherein the individual loss of life score of a household is averaged for the total loss of life score.

10. The device of claim 7, wherein a total loss of income score is calculated from an average of a percent funded for a benefit coverage of a short-term disability event and a percent funded for a benefit coverage of a long-term disability event.

11. The device of claim 10, wherein the percent funded for the benefit coverage of the short-term disability event is calculated by multiplying monthly H.U.G. expenses times six to find a short-term disability benefit amount, wherein the short-term disability benefit amount is divided into an available non-retirement capital as and short-term disability plans to find the percent funded for the benefit coverage of the short term disability event.

12. The device of claim 11, wherein the percent funded for the benefit coverage of long term disability event is calculated by multiplying the monthly H.U.G. expenses multiplied by a number of months to reach eligibility to find a long term disability benefit amount, wherein the long term disability benefit amount is divided into remaining non-retirement capital and long-term disability plans as well as social security disability to find the percent funded for the benefit coverage of the long term disability event.

13. The device of claim 7, wherein the loss of property score is calculated by dividing an actual numbers into target numbers to find a percent funded wherein an average percentile funded over all categories is multiplied into a weighted % per chart to find the loss of property score.

14. The device of claim 7, wherein the loss of health score is calculated by dividing total long-term care benefit coverage available into cumulative expenses for an average home health care expense for a state of residence with a duration of stay of three years to find a percent funded wherein the percent funded is multiplied into a weighted percent to find the loss of health score.

15. The device of claim 6, wherein the debt management score is calculated by finding a difference between a target percentile and an actual percentile to find a percentile funded for each category wherein when the actual percentile is within a range, then an automatic 100 percent is awarded for that category wherein an average total percentile funded is multiplied by 210 to give the debt management score.

16. The device of claim 6, wherein the breathing room score is calculated by dividing a total current breathing room savings into a breathing room goal to find a percent funded, wherein the percent funded is multiplied by 140 to find the breathing room score.

17. The device of claim 6, wherein the estate planning score is calculated by receiving answers to a series of questions wherein a positive response earns a portion of a contribution wherein a total contribution percentage is multiplied into corresponding points possible to give the estate planning score.

18. The device of claim 5, wherein the income distribution score is calculated by determining a percentage of fixed or essential expenses that are completely covered by “Safety-First” income sources or a 3% or less withdrawal rate from savings then multiplying the percentage by 280 to vie the income distribution score.

19. The device of claim 1, wherein the user specific information is collected from third party sources.

20. The device of claim 1, wherein the user specific information includes user location and the one or more processors are further configured to determine which of the contributing scores to use to obtain the total score based on the user location.
